(19) United States
(12) Patent Application Publication
(10) Pub. No.: US 2006/0204728 A1
(43) Pub. Date: Sep. 14, 2006

(54) Tintable and wearable composite material products

(76) Inventor: A-Pin Lin, Chang Hwa city (TW)

Correspondence Address: CHARLES E. BAXLEY, ESQ., 90 JOHN STREET, THIRD FLOOR, NEW YORK, NY, 10038, US

(21) Appl. No.: 11/075,574

(22) Filed: Mar. 9, 2005

(51) Int. Cl. B41M 5/00

(52) U.S. Cl. 428/195.1

(57) ABSTRACT

The present invention relates to a tintable scratch resistant composite material product whose surface is laminated with a colorful layer, and the color layer is further covered by a scratch resistant layer made of transparent material (transparent or semi-transparent), so that the composite material is not only improved in appearance but also can be prevented from being scathed. Furthermore, a pattern can be made between the colorful layer of and the wearable layer.

### BACKGROUND OF THE INVENTION

1. Field of the Invention

The present invention relates to a composite material product, and more particularly to a tintable and wearable composite material product.

2. Description of the Prior Arts

Since composite material has the advantages of high strength, high toughness, lightweight and corrosion resistance, composite material products have found a wide application in different fields, such as aviation industry, marine transport, land transport facilities, sports and leisure equipments. However, the composite material products still have the following defects:

First, as far as a bicycle seat post made of composite material is concerned, as shown in FIG. 1, in which, the seat post 11 is made of composite material (such as carbon fiber) and is lightweight, however, the shortcoming of the composite material is less wearable, so that the seat post 11 may be scratched and worn off after being assembled with the seat tube 12, or even worse, it may be broken when subjected to an improper force.

Second, the composite material is always single colored (such as black), adversely affecting the aesthetic appearance of the composite material products, and as a result, the problems of color inconsistence will be caused when the composite material product is assembled with other products.

Third, patterns can be made on the composite material products by nothing more than paint spraying or transfer printing, however, by using whatever methods, the patterns are simply formed on the surface of the composite material products, thereby, the patterns may be peeled off or scratched.

The present invention has arisen to mitigate and/or obviate the afore-described disadvantages.

### SUMMARY OF THE INVENTION

The primary objective of the present invention is to provide a tintable and wearable composite material product comprising a colorful layer formed on a surface thereof and a wearable layer covering the colorful layer, the colorful layer helps to improve the aesthetic appearance of the composite material product, while the wearable layer can prevent the surface of the composite material product from being scratched.

The secondary objective of the present invention is to provide a tintable and wearable composite material product comprising a pattern layer formed between the colorful layer and the wearable layer, so that the composite material product can be decorated with patterns and the patterns can be prevented by the wearable layer from being scratched.

A tintable and wearable composite material product provided in accordance with the present invention comprises a colorful layer formed on a surface thereof and a wearable layer covering the colorful layer, wherein the wearable layer is made of transparent material and serves as an abutment surface of the composite material product to other components.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a seat post made of composite material in accordance with the present invention;

FIG. 2 is a perspective view of a composite material tube in accordance with a first embodiment of the present invention;

FIG. 3 is a cross sectional view of a composite material tube in accordance with the first embodiment of the present invention;

FIG. 4 is an operational view of showing a composite material seat post in accordance with the first embodiment of the present invention being assembled with the seat tube;

FIG. 5 is a perspective view of a composite material tube in accordance with a second embodiment of the present invention;

FIG. 6 is a cross sectional view of a composite material tube in accordance with a second embodiment of the present invention.

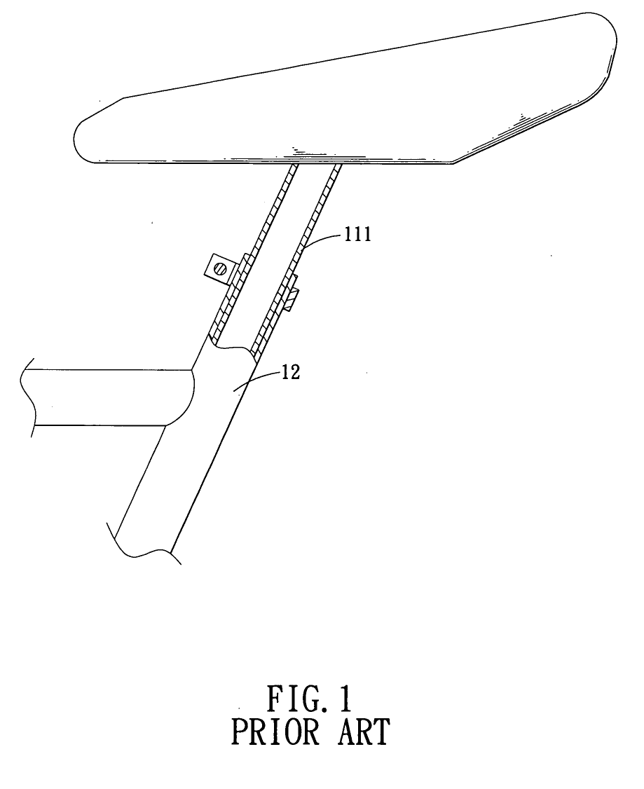

### DETAILED DESCRIPTION OF THE PREFERRED EMBODIMENTS

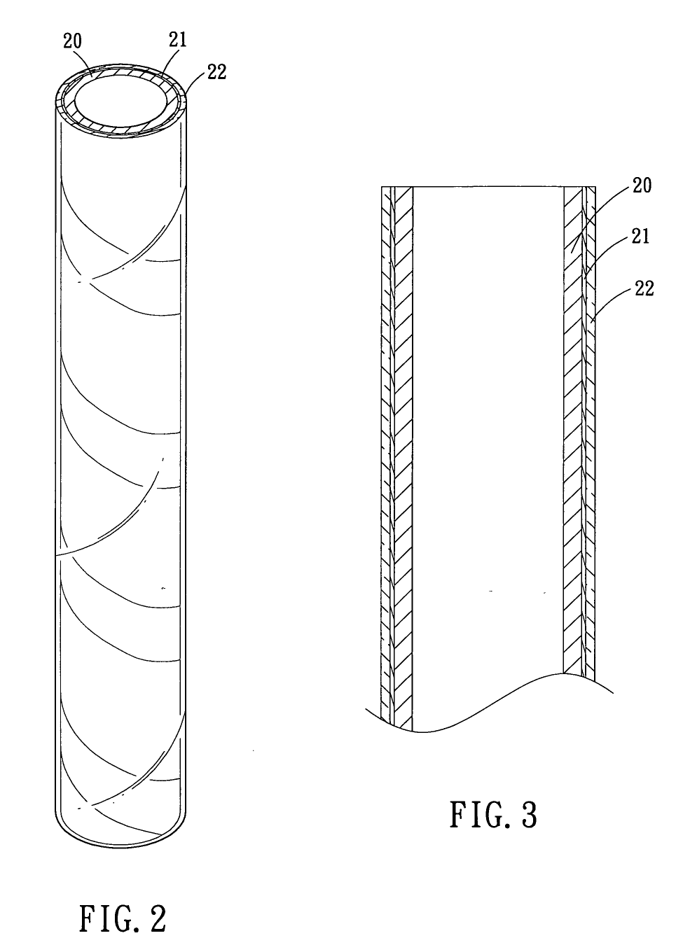

Referring to FIGS. 2 and 3, a tintable and wearable composite material product in accordance with the present invention is a tube 20 whose surface is laminated with a colorful layer 21, and then the colorful layer 21 is covered with wearable layer 22 made of transparent material (such as: transparent, semitransparent, mono-color semitransparent, nano-composite, nano-coating, polyester coating, or other wearable coating material), and the wearable layer 22 serves as an abutment surface to other components. The colorful layer 21 and the wearable layer 22 are formed by paint spraying or other methods. The colorful layer 21 can improve the aesthetic appearance of the tube 20, while the wearable layer 22 can prevent the surface of the tube 20 from being scratched. Therefore, the composite material tube 20 is not only lightweight, but also has attractive appearance and high resistance to scratch.

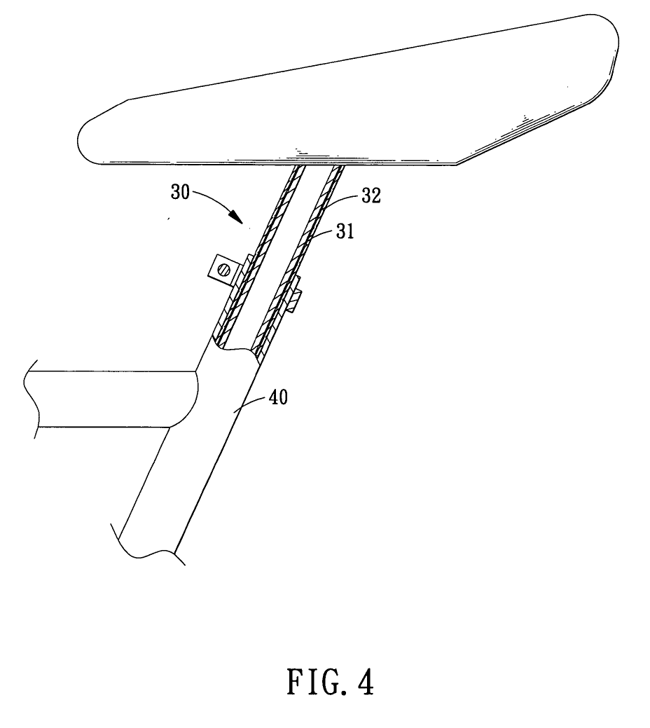

Referring to FIG. 4, the composite material tube in accordance with the present invention also can be a bicycle seat post 30, when the seat post 30 is assembled with the seat tube 40, the wearable layer 32 can prevent the seat post 30 from being scratched, while the colorful layer 30 can beautify the appearance of the tube 30.

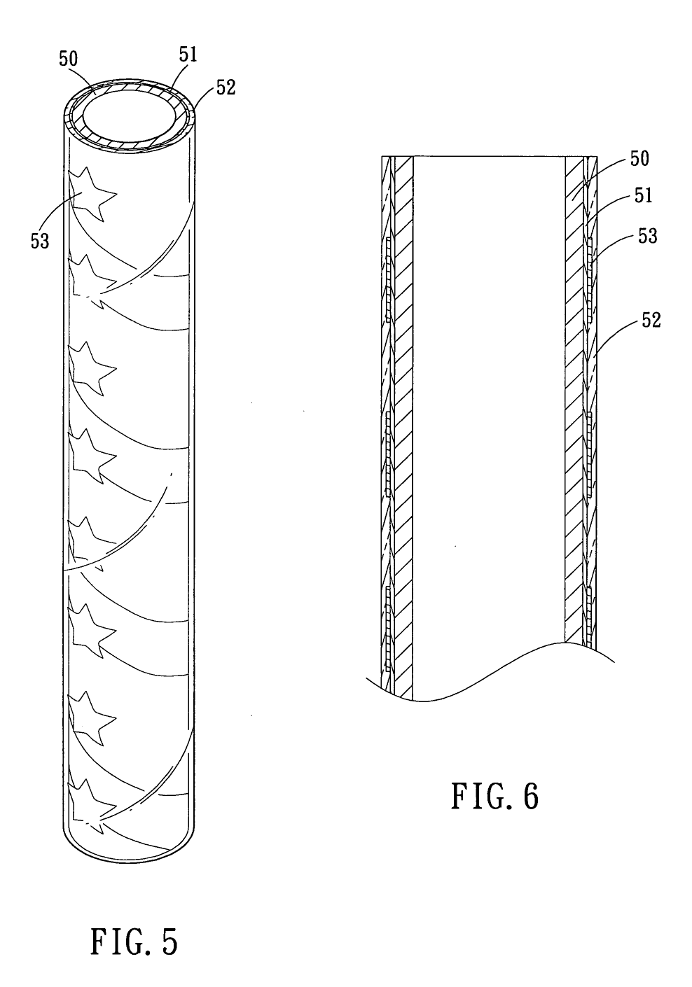

Referring next to FIG. 5, a tintable and wearable composite material product in accordance with a second preferred embodiment of the present invention is also a tube 50 whose surface is laminated with a colorful layer 51 and wearable layer 52 covering the colorful layer 51. The wearable layer 52 is made of transparent material (transparent or semitransparent) and serves as an abutment surface to other components. This embodiment is similar with the first embodiment, except:

A pattern layer 53 is formed between the colorful layer 51 and the wearable layer 52, which can be figure, letter, number, and the like, so that the tube can be decorated with patterns and the patterns can be prevented by the wearable layer 52 from being scratched.

While we have shown and described various embodiments in accordance with the present invention, it should be clear to those skilled in the art that further embodiments may be made without departing from the scope of the present invention.

What is claimed is:

1. A tintable and wearable composite material product comprising a colorful layer formed on a surface thereof and a wearable layer covering the colorful layer, wherein the wearable layer is made of transparent material and serves as an abutment surface of the composite material product to other components.

2. The tintable and wearable composite material product as claimed in claim 1, wherein the wearable layer is transparent.

3. The tintable and wearable composite material product as claimed in claim 1, wherein the wearable layer is semitransparent.

4. The tintable and wearable composite material product as claimed in claim 1, wherein a pattern layer is formed between the colorful layer and the wearable layer.

5. The tintable and wearable composite material product as claimed in claim 1, wherein the wearable layer is mono-color semitransparent.

6. The tintable and wearable composite material product as claimed in claim 1, wherein the wearable layer is made of nano-composite material.

7. The tintable and wearable composite material product as claimed in claim 1, wherein the wearable layer is made of other nano-coating material.

8. The tintable and wearable composite material product as claimed in claim 1, wherein the wearable layer is made of polyester coating material.

9. The tintable and wearable composite material product as claimed in claim 1, wherein the wearable layer is made of other wearable coating material.
